(19) United States
(12) Patent Application Publication
(10) Pub. No.: US 2024/0154140 A1
(43) Pub. Date: May 9, 2024

(54) MAGNETIC FRAGMENT FILTER

(71) Applicant: ESS TECH, INC., Wilsonville, OR (US)

(72) Inventor: Samuel Ryan, Wilsonville, OR (US)

(21) Appl. No.: 18/495,591

(22) Filed: Oct. 26, 2023

Related U.S. Application Data
(60) Provisional application No. 63/382,827, filed on Nov. 8, 2022.

(51) Int. Cl. H01M 8/04276; H01M 8/0438; H01M 8/04858; H01M 8/18

(52) U.S. Cl. CPC H01M 8/04276; H01M 8/0438; H01M 8/04917; H01M 8/188

(57) ABSTRACT

Systems and methods are provided for an energy storage system. In one example, the energy storage system comprises a first tube configured to flow an electrolyte solution to a pump, a second tube extending through the first tube, the second tube hermetically sealed from an interior of the first tube, and a wire wound within the second tube configured to generate a magnetic field.

### CROSS REFERENCE TO RELATED APPLICATIONS

The present application claims priority to U.S. Provisional Application No. 63/382,827 entitled “MAGNETIC FRAGMENT FILTER” filed Nov. 8, 2022. The entire contents of the above identified application are hereby incorporate by reference for all purposes.

### FIELD

The present description relates generally to managing magnetic fragments in a redox flow battery

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFB s) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. During battery deplating (e.g., discharge), fragments of iron may enter an electrolyte solution and pass through an electrolyte pump. The electrolyte pump may be a magnetic-drive centrifugal pump, which may result in the iron magnetically adhering to an impeller housing. The iron fragments may be dragged across and score the surface and of the impeller housing. The iron may dissolve but the scoring may remain and result in premature degradation of the electrolyte pump. Thus, there is a demand for routing the iron fragments away from the electrolyte pump.

In one example, the issues may be addressed by an energy storage system including a first tube configured to flow an electrolyte solution to a pump, a second tube extending through the first tube, the second tube hermetically sealed from an interior of the first tube, and a wire wound within the second tube configured to generate a magnetic field.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system.

FIG. 2 shows a magnetic filter arranged in an electrolyte flow tube.

FIG. 3 shows a cross-section of the magnetic filter and the electrolyte flow tube taken along a cutting plane 3-3 in FIG. 2.

FIG. 4 shows a method for operating the magnetic filter.

### DETAILED DESCRIPTION

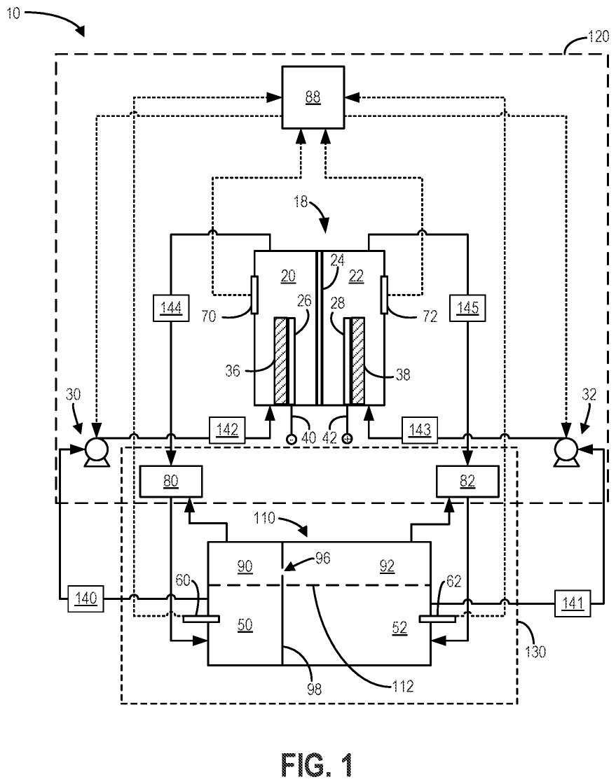

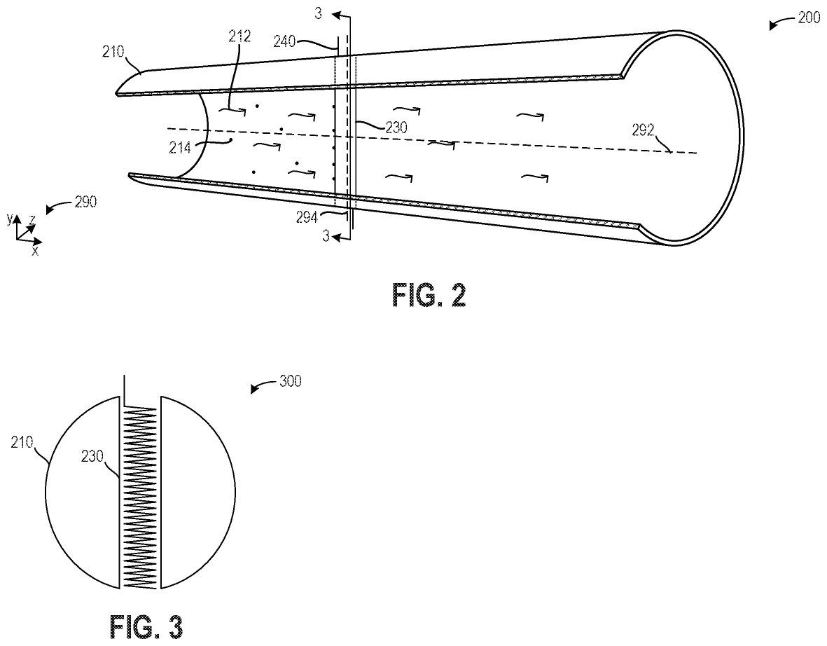

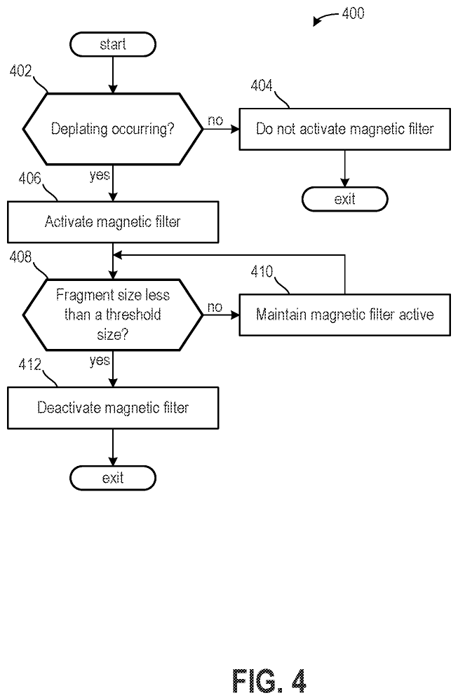

The following description relates to systems and methods for a magnetic filter arranged in a redox flow battery system. An example of a redox flow battery system is shown schematically in FIG. 1, where the redox flow battery system may be an all-iron redox flow battery system leveraging iron redox reactions to generate electrical power. As described in FIG. 1, the redox flow battery system may include pumps for circulating electrolyte between an electrolyte tank and battery electrodes. The electrolyte may entrain iron particles that may be deplated from a negative electrode of the battery electrodes which may degrade the pumps. FIG. 2 shows a magnetic filter arranged in an electrolyte flow tube which may be used to trap the iron particles and mitigate adverse effects of the iron particles on the pumps. FIG. 3 shows a cross-section of the magnetic filter and the electrolyte flow tube taken along a cutting plane 3-3 in FIG. 2. In some embodiments, the magnetic filter may be passive and may generate a magnetic field during all operating conditions of the redox flow battery system. Additionally or alternatively, the magnetic field may be actively controlled by an example method shown in FIG. 4.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44 V (negative electrode) (1)

Fe²⁺↔2Fe³⁺+2e⁻+0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively. The negative and positive electrolyte pumps 30 and 32 may be magnetic-drive centrifugal pumps, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow controller or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe²⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the likelihood of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIG. 5, the controller may control bypass valves configured in a flow path of hydrogen gas and electrolyte respectively. Opening and closing bypass valves may allow control of a speed and amount of hydrogen gas being pumped by the electrolyte driven hydrogen pump. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be pre-formed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

As will be described herein, a magnetic filter may be arranged in the redox flow battery system 10 and configured to capture iron fragments mixed with the electrolyte solution. The magnetic filter may retain the iron fragments until a size of the iron fragments is less than a threshold size and less likely to degrade surfaces of an electrolyte pump. In one example, iron battery systems may experience iron entering solution during discharge due to inconsistent plating quality. Iron flakes (e.g., fragments) may enter the solution and degrade the electrolyte pump 30 and/or 32. Thus, it may be desired to capture these iron fragments to increase a longevity of the electrolyte pump 30 and/or 32.

The redox flow battery system 10 may include one or more magnetic filters arranged in various passages. A first magnetic filter 140 may be arranged between the external negative electrolyte chamber 50 and the negative electrolyte pump 30. A second magnetic filter 141 may be arranged between the external positive electrolyte chamber 52 and the positive electrolyte pump 32. A third magnetic filter 142 may be arranged between the negative electrolyte pump 30 and the negative electrode compartment 20. A fourth magnetic filter 143 may be arranged between the positive electrolyte pump 32 and the positive electrode compartment 22. A fifth magnetic filter 144 may be arranged between the negative electrode compartment 20 and the electrolyte rebalancing reactor 80. A sixth magnetic filter 145 may be arranged between the positive electrode compartment 22 and the electrolyte rebalancing reactor 82. An example of the magnetic filter is shown in FIG. 2. In one example, the magnetic filter is arranged at only an inlet of the negative electrolyte pump 30.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Turning now to FIG. 2, it shows an embodiment 200 of a first tube 210 and a second tube 230. The second tube 230 may extend through, at an angle, at least a portion of the first tube 210. Portions of the second tube 230 occluded by the first tube 210 may be illustrated via dashed lines. The second tube 230 may be in face-sharing contact with interior surfaces of the first tube 210. The first tube 210 may be a non-limiting example of any of the passages configured to flow fluids in the redox flow battery system 10 of FIG. 1. Second tube 230 may be an example tube of the first through sixth magnetic filters 140-145 of FIG. 1.

An axis system 290 including three axes, namely an x-axis parallel to a longitudinal direction, a y-axis parallel to a lateral direction, and a z-axis parallel to a traverse direction. In one example, the longitudinal direction is a horizontal direction, the lateral direction is a vertical direction, and the z-axis is normal to the horizontal and vertical directions. The first tube 210 includes a first central axis 292 parallel to the x-axis. The second tube 230 includes a second central axis 294 parallel to the y-axis and normal to the first central axis 292. As such, the second tube 230 is perpendicular to the first tube 210.

The first tube 210 may be a flow tube through which an electrolyte solution, shown via arrows 212, may flow. The electrolyte solution in the first tube 210 may flow to an electrolyte pump, such as the first electrolyte pump 30 or the second electrolyte pump 32 of FIG. 1, when a battery is deplating (e.g., discharging). During the deplating, iron (e.g., Fe²⁺ or Fe³⁺), shown via black circles 214, may flow with the electrolyte solution through the first tube 210. As described above, in the absence of a magnetic filter, the iron may adhere to a housing of the pump and score surfaces thereof, thereby reducing a longevity of the pump. In some examples, additionally or alternatively, deplating may occur through corrosive mechanisms outside of discharge operation.

The second tube 230 may extend through at least a portion of the first tube 210. In one example, each of the first tube 210 and the second tube 230 are cylindrical, wherein the first tube 210 is a larger cylinder than the second tube 230. In one example, a height of the second tube 230, measured along the second central axis 294, is equal to a diameter of the first tube 210. The second tube 230 may include a diameter smaller than the diameter of the first tube 210. The electrolyte solution may flow around surfaces of the second tube 230.

In some examples, the second tube 230 may include a non-uniform shape. For example, the second tube 230 may include a cone-shape, wherein a diameter of the second tube 230 is wider at a lower region of the first tube 230 relative to a direction of gravity parallel to the y-axis. This may be due to a greater amount of iron flowing near the lower region of the first tube 230. Additionally or alternatively, the second tube 230 may be wider along a middle section of the tube and narrow as it approaches a coupling with the first tube 210. In such an example, one of the first tube 210 or the second tube 230 may be manufactured in two-pieces welded together. In some examples, additionally or alternatively, the second tube 230 may include other surface features, such as a texturing, protrusions, or other features that increase a contact between the second tube 230 and the electrolyte solution.

The second tube 230 may include a wire 240 wound therein that, when activated, generates a magnetic field. In one example, the combination of the second tube 230 and the wire 240 may be a magnetic filter and referred to as such herein. The embodiment 200 of the magnetic filter including the second tube 230, with the wire 240 wound therein, extending through the first tube 210 configured to direct electrolyte solution may be a non-limiting example of the first through sixth magnetic filters 140-145 of FIG. 1.

While the example of FIG. 2 illustrates only one magnetic filter arranged in the first tube 210, embodiments may exist where multiple magnetic filters are arranged in the first tube 210 at a same or adjacent areas. For example, a third tube, identical to the second tube 230, may extend through each of the first tube 210 and the second tube 230. The third tube may include a wire configured to generate a magnetic field. The third tube may be angled to each of the first tube and the second tube. The third tube may be welded to each of the first tube 210 and the second tube 230. In one example, a magnetic filter comprising the second tube 230 and the third tube may comprise a t-shape, a plus-shape, an X-shape, or other cross shape. Additionally or alternatively, in some embodiments, multiple magnetic filters may be arranged in series within the first tube 210. An orientation of the magnetic filters may be different such that a downstream magnetic filter may be arranged along an axis or a plane different than an upstream magnetic filter. In some examples, the second tube 230 and the third tube and/or additional tubes may be misaligned with one another relative to the direction of electrolyte flow.

The magnetic field may draw the iron in the electrolyte solution to adhere to an outer surface of the second tube 230, as illustrated. Iron may adhere to upstream surfaces of the second tube, downstream surfaces of the second tube, or surfaces therebetween. Upstream surfaces may face a direction opposite a direction of electrolyte flow and downstream surface may face a direction parallel to the direction of electrolyte flow. The electrolyte solution may be corrosive and dissolve the iron fragments collected on the second tube 230. In some examples, current supplied to the wire 240 may be actively controlled (e.g., via instructions stored in memory of controller 88) to capture and hold the iron fragments until a size thereof is less than a threshold size. By doing this, the electrolyte solution flowing to the pump may be free of larger iron fragments, which may improve a longevity of the pump. By actively controlling the magnetic filter, a power consumption thereof may be reduced. In some example, the magnetic filter may be active during all active operations of the battery system.

In some examples, the magnetic filter may attract iron fragments with a size greater than a threshold size. A strength of the magnetic filter may be configured to attract iron fragments greater than the threshold size. In one example, the threshold size may be based on a size of iron fragments capable of degrading (e.g., scoring) surfaces of the pump. Thus, iron fragments smaller than the threshold size may be too small to degrade the pump. The magnetic attraction between the magnetic filter and iron fragments less than the threshold size may be too weak, allowing the smaller iron fragments to flow to the pump without adhering to the magnetic filter. By sizing the magnetic filter in this way, a packaging size of the magnetic filter may be reduced while mitigating degradation to the pump via capturing iron fragments greater than the threshold size.

Turning now to FIG. 3, it shows a cross-sectional view 300 taken along the cutting plane 3-3 of FIG. 2. The cross-sectional view 300 illustrates the wire 240 coiled within the second tube 230. The second tube 230 is shown extending through the a flow path of the first tube 210, wherein an interior of the second tube 230 is sealed from the flow path. In one example, a pair of cutouts may be arranged in a surface of the first tube 210 through which the second tube 230 may extend. The second tube 230 may be welded to the cutouts. In one embodiment, an interior of the first tube 210 may be sealed from an external environment via the welds and an interior of the second tube 230 may be hermetically sealed from the interior of the first tube 210 via the welds and surfaces of the second tube. Thus, the second tube 230 is watertight and the electrolyte solution, iron fragments, or other elements flowing through the first tube 210 do not enter the second tube 230.

Turning now to FIG. 4, it shows a method 400 for activating the magnetic filter. The method 400 begins at 402, which includes determining if deplating is occurring. Deplating may be occurring if the electrolyte pump is active or when the battery is discharging. Additionally or alternatively, the method 400 may optionally activate the magnetic filter during all conditions where the electrolyte pump is active, such as during discharge and recharging. In some examples, the magnetic filter may be activated within a first threshold time of an activation of the electrolyte pump. For example, the magnetic filter may be activated before, after, or in conjunction with the activation of the electrolyte pump.

If deplating is not occurring, then at 404, the method 400 may include not activating the magnetic filter. As such, current may not flow to the wire and the magnetic filter may not be active. A magnetic field is not generated.

If deplating is occurring, then at 406, the method 400 may include activating the magnetic filter. Current may flow to the wire, which may generate a magnetic field and cause the iron fragments to adhere to surfaces of the second tube via magnetic attraction. The iron fragments and the electrolyte solution remain outside of the second tube when the magnetic filter is activated.

In some embodiments, additionally or alternatively, an electrolyte pump rate may be adjusted in response to the magnetic filter being activated. For example, the electrolyte pump rate may be reduced to promote increase adhesion between the iron fragments and the second tube.

At 408, the method 400 may include determining if the fragment size is less than the threshold size. The iron fragments adhered to the second tube may erode as electrolyte flows through the first tube and across surfaces of the second tube. In one example, the threshold size is based on an iron fragment size where scoring or other form of degradation to the pump via the iron fragments no longer occurs or is less likely to occur. In some examples, the iron fragments may release from the magnetic filter even when the magnetic filter is active once the iron fragments are less than the threshold size. This may be due to a magnetic attraction between the magnetic filter and the smaller iron fragment being weaker than a force of the flow of the electrolyte solution. The fragment size may be less than the threshold size if a threshold amount of electrolyte has flowed through the first tube, which may be associated to an electrolyte flow rate. Additionally or alternatively, the method may include determining if a duration of time and/or a second threshold time has elapsed, wherein the duration of time may be based on an iron fragment exposure to an electrolyte solution. The duration and/or amount of electrolyte may be dependent on a rate of the electrolyte pump in some examples. In one embodiment, if the electrolyte pump rate is relatively high, then an iron fragment size may be reduced more quickly relative to lower pump rates. If the fragment size is not less than the threshold size, then the method 400 may proceed to 410, which includes maintaining the second tube magnet active. By doing this, the iron fragments adhered to the second tube may dissolve to a desired size to mitigate degradation to the pump.

If the iron fragment size is less than the threshold size, then at 412, the method 400 may include deactivating the magnetic filter. Current may no longer be supplied to the wire within the second tube, resulting in the iron fragments releasing from the surfaces of the second tube and flowing to the pump. The reduced size iron fragments may be less likely to score the pump. By actively controlling the current flow to the wire, a magnetic field may be generated when desired, such as when deplating is occurring or when the electrolyte pump is active. Battery power may be saved by deactivating the magnetic field and stopping current flow to the wire when deplating is not occurring or when the electrolyte pump is deactivated.

FIGS. 2-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure provides support for an energy storage system including a first tube configured to flow an electrolyte solution to a pump, a second tube extending through the first tube, the second tube hermetically sealed from an interior of the first tube, and a magnetic filter within the second tube configured to generate a magnetic field. A first example of the disclosure further includes where the pump is a magnetic-drive centrifugal pump. A second example of the disclosure, optionally including the first example, further includes where the pump is configured to pump the electrolyte solution to an electrode of the energy storage system. A third example of the disclosure, optionally including one or more of the previous examples, further includes where the energy storage system comprises a redox iron flow battery. A fourth example of the disclosure, optionally including one or more of the previous examples, further includes where the second tube is welded to the first tube. A fifth example of the disclosure, optionally including one or more of the previous examples, further includes where a height of the second tube is equal to a diameter of the first tube, and wherein a diameter of the second tube is less than the diameter of the first tube. A sixth example of the disclosure, optionally including one or more of the previous examples, further includes where the magnetic filter is a wire wound within the second tube, and wherein the wire is actively controlled. A seventh example of the disclosure, optionally including one or more of the previous examples, further includes where the second tube is angled to the first tube. An eighth example of the disclosure, optionally including one or more of the previous examples, further includes where the second tube is perpendicular to the first tube.

The disclosure provides additional support for a method including in response to a pump flowing electrolyte solution through a first tube, activating a magnetic field via a wire wound in a second tube, the second tube extending through and physically coupled to the first tube. A first example of the method further includes where collecting iron fragments on the second tube, wherein the second tube having the magnetic field temporary holds collected iron fragments on a surface of the second tube until the electrolyte solution dissolves the collected fragments back into solution. A second example of the method, optionally including the first example, further includes deactivating the magnetic field in response to an iron fragment size being less than a threshold size. A third example of the method, optionally including one or more of the previous examples, further includes where the second tube extends through a cut-out of the first tube and is completely arranged within the first tube. A fourth example of the method, optionally including one or more of the previous examples, further includes where the second tube is hermetically sealed from an interior of the first tube. A fifth example of the method, optionally including one or more of the previous examples, further includes where activating the magnetic field is within a first threshold duration of activating the pump, and deactivating the magnetic field is within a second threshold duration of activating the pump.

The disclosure provides further support for a redox iron flow battery assembly includes a first tube fluidly coupled to an electrolyte pump and a second tube perpendicular to the first tube, wherein a wire is wound within the second tube and configured to generate a magnetic field. A first example of the redox iron flow battery assembly further includes where the first tube and second tube are arranged between the electrolyte pump and electrode compartments of a battery. A second example of the redox iron flow battery assembly, optionally including the first example, further includes where the first tube and second tube are arranged between the electrolyte pump and positive and negative electrolyte chambers. A third example of the redox iron flow battery assembly, optionally including one or more of the previous examples, further includes where the first tube and second tube are arranged between the electrolyte pump and rebalancing reactors. A fourth example of the redox iron flow battery assembly, optionally including one or more of the previous examples, further includes where a controller with computer-readable instructions stored on memory thereof that cause the controller to flow current to the wire and generate the magnetic field in response to the electrolyte pump being active, and wherein the instructions further cause the controller to block current to the wire in response to one or more of the electrolyte pump being inactive or a size of iron fragments collected on the second tube being less than a threshold size.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An energy storage system, comprising:
a first tube configured to flow an electrolyte solution to a pump;
a second tube extending through the first tube, the second tube hermetically sealed from an interior of the first tube; and
a magnetic filter within the second tube configured to generate a magnetic field.

2. The energy storage system of claim 1, wherein the pump is a magnetic-drive centrifugal pump.

3. The energy storage system of claim 1, wherein the pump is configured to pump the electrolyte solution to an electrode of the energy storage system.

4. The energy storage system of claim 1, wherein the energy storage system comprises a redox iron flow battery.

5. The energy storage system of claim 1, wherein the second tube is welded to the first tube.

6. The energy storage system of claim 1, wherein a height of the second tube is equal to a diameter of the first tube, and wherein a diameter of the second tube is less than the diameter of the first tube.

7. The energy storage system of claim 1, wherein the magnetic filter is a wire wound within the second tube, and wherein the wire is actively controlled.

8. The energy storage system of claim 1, wherein the second tube is angled to the first tube.

9. The energy storage system of claim 1, wherein the second tube is perpendicular to a central axis of the first tube.

10. A method, comprising:
in response to a pump flowing electrolyte solution through a first tube, activating a magnetic field via a wire wound in a second tube, the second tube extending through and physically coupled to the first tube.

11. The method of claim 10, further comprising collecting iron fragments on the second tube, wherein the second tube having the magnetic field temporary holds collected iron fragments on a surface of the second tube until the electrolyte solution dissolves the collected fragments back into solution.

12. The method of claim 10, further comprising deactivating the magnetic field in response to an iron fragment size being less than a threshold size.

13. The method of claim 10, wherein the second tube extends through a cut-out of the first tube and is arranged within the first tube.

14. The method of claim 10, wherein the second tube is hermetically sealed from an interior of the first tube.

15. The method of claim 10, wherein activating the magnetic field is within a first threshold duration of activating the pump, and deactivating the magnetic field is within a second threshold duration of activating the pump, the second threshold duration greater than the first threshold duration.

16. A redox iron flow battery assembly, comprising:
a first tube fluidly coupled to an electrolyte pump; and
a second tube perpendicular to the first tube, wherein a wire is wound within the second tube and configured to generate a magnetic field.

17. The redox iron flow battery assembly of claim 16, wherein the first tube and second tube are arranged between the electrolyte pump and electrode compartments of a battery.

18. The redox iron flow battery assembly of claim 16, wherein the first tube and second tube are arranged between the electrolyte pump and positive and negative electrolyte chambers.

19. The redox iron flow battery assembly of claim 16, wherein the first tube and second tube are arranged between the electrolyte pump and rebalancing reactors.

20. The redox iron flow battery assembly of claim 16, further comprising a controller with computer-readable instructions stored on memory thereof that cause the controller to flow current to the wire and generate the magnetic field in response to the electrolyte pump being active, and wherein the instructions further cause the controller to block current to the wire in response to one or more of the electrolyte pump being inactive or a size of iron fragments collected on the second tube being less than a threshold size.
